(19) United States
(12) Patent Application Publication
(10) Pub. No.: US 2005/0153686 A1
(43) Pub. Date: Jul. 14, 2005

(54) Controlling sending of messages in a communication system

(75) Inventors: Jan Kall, Esbo (FI); Jens Staack, Ojakkala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 10/781,666

(22) Filed: Feb. 20, 2004

(30) Foreign Application Priority Data
Jan. 9, 2004 (FI) 20040023

(51) Int. Cl. H04M 11/10

(52) U.S. Cl. 455/412.1

(57) ABSTRACT

The present invention relates to a method for controlling the sending of messages in a communication system. The method comprises providing a network entity with restriction information associated with terminating parties in the communication system. The method further comprises determining at least one terminating party for a message to be sent and controlling sending of the message based on the restriction information.

### FIELD OF INVENTION

The invention relates to communication systems, and more particularly to controlling sending of messages in a communication system between an originating party and at least one terminating party.

### BACKGROUND OF INVENTION

A communication system can be seen as a facility that enables communications between two or more entities such as user equipment and/or other nodes associated with the communication system. The communication session may comprise, for example, communication of voice, data, multimedia and so on. A user equipment may, for example, be provided with a two-way telephone call, multi-way conference call, electronic mail service or a data communication session. A user equipment may also be provided with a connection to an application server (AS), for example a service provider server, thus enabling use of services provided by the application server.

A communication system typically operates in accordance with a given standard or specification which sets out what the various entities associated with the communication system are permitted to do and how that should be achieved. For example, the standard or specification may define if the user or, more precisely, the user equipment is provided with a circuit switched service and/or a packet switched service. Communication protocols and/or parameters which are used for the connection may also be defined. In other words, a specific set of “rules”, on which the communication can be based, needs to be defined to enable communication by means of the system.

Examples of communication systems may include fixed communication systems, such as a public switched telephone network (PSTN), wireless communication systems, such as a public land mobile network (PLMN), and/or other communication networks such as an IP (Internet Protocol) and/or other packet switched data networks. Various communication systems may simultaneously be concerned in a connection.

The PSTN is a circuit switched communication system providing telephone call services, electronic mail (email) functionalities, facsimile services and so on. In the PSTN, various switching centres or switching units typically attend the routing of a connection. An intelligent network (IN) has been developed to expand and diversify the performance of the telephone network. In the IN, a service control point (SCP) manages the intelligence of the network. A service switching point (SSP) capable of communicating with the SCP may take the functionalities of a conventional switching centre.

The PLMNs are typically based on cellular technology. In cellular systems, a base transceiver station (BTS) or similar access entity serves wireless user equipment (UE) known also as mobile stations (MS) via a wireless interface between these entities. The communication on the wireless interface between the user equipment and the elements of the communication network can be based on an appropriate communication protocol. The operation of the base station apparatus and other apparatus required for the communication can be controlled by one or several control entities. The various control entities may be interconnected. One or more gateway nodes may also be provided for connecting the mobile network to other networks. For example, if the terminating party of the communication, such as a user equipment to be contacted or another destination, is located in another network than the mobile network of the originating party, the connection may be routed via the mobile network to the other network and then to the terminating party.

Examples of mobile communication systems are the Global System for Mobile Communications (GSM), General Packet Radio Service (GPRS) and Universal Mobile Telecommunications System (UMTS). In addition to call functions, the mobile communication systems may support, for example, short message service (SMS), multimedia message service (MMS) and wireless applications protocol (WAP). For example, a mobile user may access the mobile network by means of a Personal computer (PC), Personal Data Assistant (PDA), mobile station (MS) and so on. The mobile user equipment may be adapted for Internet Protocol (IP) communication to connect the network.

The Internet Protocol (IP) Multimedia network is an example of a communication system enabled to offer various types of multimedia services. IP Multimedia (IM) functionalities can be provided by means of an IP Multimedia Core Network (CN) subsystem, or briefly IP Multimedia subsystem (IMS). The IMS includes various network entities for the provision of the multimedia services. The third generation partnership project (3GPP) has defined use of the GPRS as a backbone communication system for the provision of the IMS services.

The 3GPP has also defined a reference architecture for the third generation (3G) core network which will provide the users of user equipment with access to various functionalities. This core network is divided into three principal domains. These are the Circuit Switched (CS) domain, the Packet Switched (PS) domain and the Internet Protocol Multimedia (IM) domain. The last of these, the IM domain, is for ensuring that multimedia services are adequately managed. The 3G IM domain supports the Session Initiation Protocol (SIP) as developed by the Internet Engineering Task Force (IETF). Session Initiation Protocol (SIP) is an application-layer control protocol for creating, modifying and terminating sessions with one or more parties.

Communication by means of communication systems and telecommunication, as one particular example, between people is increasing and becoming an everyday routine task. People may send messages for example by means of a short message service (SMS), electronic mail (email), multimedia message service (MMS) or IP Multimedia subsystem (IMS) or other messaging systems. Such messages may be addressed to several terminating parties at the same time. This can be done in various different ways. Some examples include creating address lists, replying to a received message using a “reply all” function available in various systems or inputting several addresses to an address field determining the terminating party.

People do not always pay much attention to every detail of the communication process, thereby increasing the risk for mistakes. For example, there may be an unwanted recipient in the list not noticed by the sender or a spelling mistake in the address. This may result in a message sent to an unwanted recipient, i.e. an unwanted terminating party. In certain cases, the sender has not paid enough attention to the content of the message thus sending a message containing, for example, company confidential information to a recipient who should receive only published information. There is therefore a need for providing a way of controlling the sending of the message.

### SUMMARY OF THE INVENTION

Embodiments of the invention aim to address one or several of the above problems or issues.

In accordance with an aspect of the invention, there is provided a method for controlling sending of messages in a communication system, the method comprising providing a network entity with restriction information associated with terminating parties in the communication system, determining at least one terminating party for a message to be sent and controlling the sending of the message based on the restriction information.

In accordance with another aspect of the invention, there is provided a communication system comprising a network entity configured to receive and manage restriction information associated with terminating parties in the communication system, determining means configured to determine at least one terminating party for a message to be sent and controlling means configured to control sending of the message based on the restriction information.

### BRIEF DESCRIPTION OF FIGURES

The invention will now be described in further detail, by way of example only, with reference to the following examples and accompanying drawings, in which:

FIG. 1 shows an example of a communication system architecture in which embodiments of the invention may be implemented;

FIG. 2 shows a flow chart illustrating an embodiment of the invention;

FIG. 3 shows an embodiment in an electronic mail (email) implementation;

FIG. 4 shows a further embodiment in an Internet Protocol Multimedia subsystem (IMS) implementation; and

FIG. 5 shows a further embodiment in a Multimedia Message Service (MMS) implementation.

### DETAILED DESCRIPTION OF PREFERRED EMBODIMENTS

Embodiments of the invention may apply to various communication sessions, such as, but not limited to, circuit switched (CS) call set-up, Internet Protocol Multimedia subsystem (IMS) service establishment, short message service (SMS), wireless applications protocol (WAP), multimedia message service (MMS), electronic mail (emails) service and Internet browsing.

Some embodiments will be described in the following by way of example, with reference to the exemplifying architecture of a communication system. It shall be appreciated that the embodiments may be applied to any suitable communication system, such as circuit switched telephone system, various electronic mail systems or multimedia service systems connected as well to a fixed communication system as to a mobile communication system and so on.

The embodiments may give the user a possibility to avoid or cancel sending information by accident to unwanted recipients. In certain embodiments, a warning message may be received when the user is about to call or send information to one or several recipients outside or inside a predefined address domain. In certain embodiments, it may be possible to block the user's attempt to call or send information to unwanted recipients.

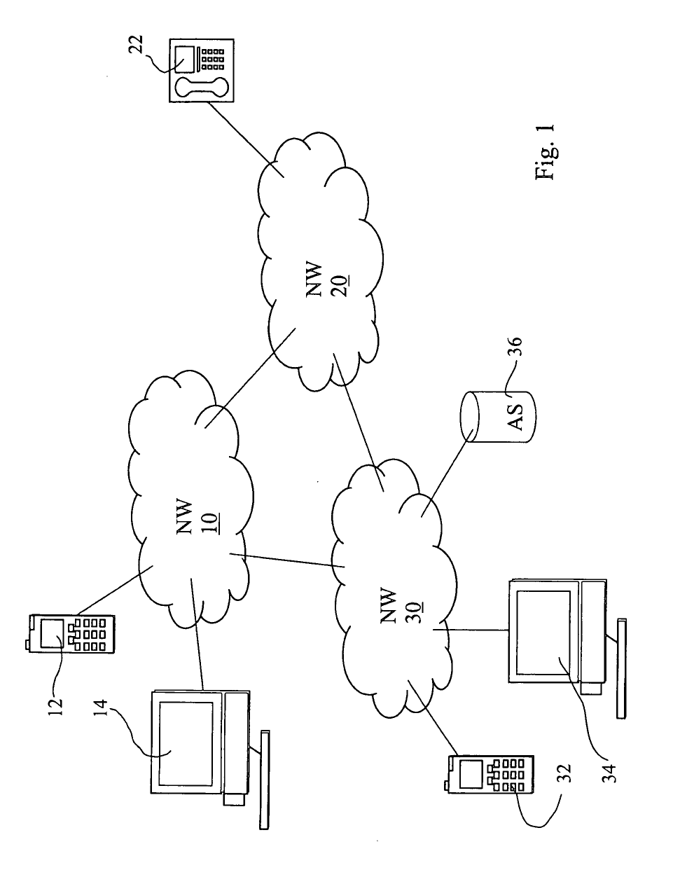

Reference is made to FIG. 1 showing an arrangement including three communication networks 10, 20 and 30 connected with a plurality of user equipments 12, 14, 22, 32, and 34. Furthermore, an application server (AS) 36 is shown in connection with the network 30.

A user equipment may act as an originating party sending a message or as a terminating party receiving a message. The message is routed via the appropriate communication networks from the originating party to the terminating party. The communication networks typically comprise various switching and other control entities and gateways for enabling the communication for interfacing a single communication network with one or more communication networks. In order to enhance clarity, these control entities are not shown in FIG. 1 but only lines are used to denote the interface between networks. The communication systems may include any communication networks, such as the PSTN, the GSM, the Internet and/or the GPRS.

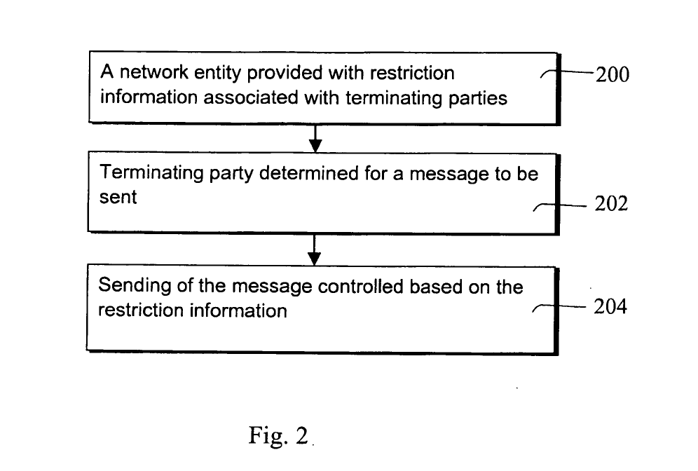

FIG. 2 is a flowchart showing steps for an embodiment. In step 200, a network entity is provided with restriction information associated with terminating parties in the communication system. In step 202, at least one terminating party is determined for a message to be sent. In step 204, sending of the message is controlled based on the restriction information associated with the at least one terminating party.

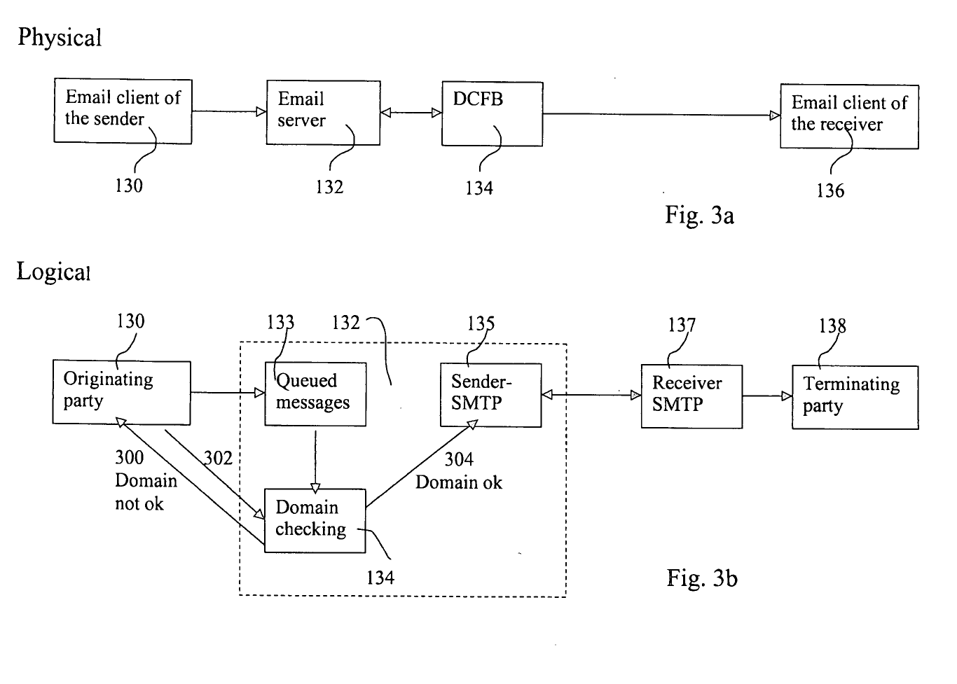

An example of an embodiment implemented in an email system is illustrated in FIG. 3a, showing the physical architecture of the embodiment, and FIG. 3b, showing the respective logical architecture. Typically, when sending an email, a user may write email addresses of the recipients to dedicated fields, such as the “TO”, “CC” (carbon copy) or “BCC” (blind carbon copy) fields. A user receiving the email may reply to the email by a specific function assisting in filling the fields automatically (e.g. “reply all”). The user may put in some text or Multipart Internet Mail Extension (MIME) type(s) to the email body and send the email simply by using function “send”. It may happen that when the email has been sent, the user only then realizes that certain email addresses were included in the recipient fields that should not have got the email in question. However, in most cases it is too late. Only if the receivers are within the same email service domain may certain email software recall the email.

A user, i.e. the originating party or sender, may employ an email client program 130, such as Microsoft Outlook, Mozilla or Pegasus, for sending emails. The email client program 130 transfers the dispatched email message to an email server 132, which is running a server program, such as Microsoft Exchange or Mercury. The embodiments of the invention may be implemented, for example, using a set of restriction rules in the email client program 130 or in a separate domain checking functional block (DCFB) 134 included in or connected to the email server 132.

A user, an email server operator or some other party, such as the employer of the user, may define rules for restricting sending of information for example based on the message type and/or the type or location of the terminating party. A party creating a message or any other party may determine the type of the message by classifying the message using different criteria. The classification may be based on the type of the information contained in the message and may define for example private, company confidential, customer confidential or public information. When sending the message, the classification may be included in the message and used for restricting purposes.

In the embodiment of FIGS. 3a and 3b, the DCFB 134 connected to or included in the email server 132 is adapted to check all messages transferred to the email server 132. Messages may first be transferred to a queuing zone 133 in the email server 132 and then checked in the DCFB 134 in turn. The DCFB 134 may check whether a specific user has defined a restriction rule or a set of restriction rules that apply for a recipient, i.e. the terminating party or receiver, appearing in a particular message.

If such a restriction rule applies for one or more of the recipients of the message, the DCFB 134 may block the message from being sent to such recipient(s). The user 130 sending the message, i.e. the originating party or sender, may then be warned that a restriction rule applies in relation to the message in question. The sender may also be asked whether the message is to be delivered to the recipient in spite of the restriction rule. This functionality may be implemented so that the DCFB 134 sends a special message 300 or a normal email to the originating party 130, as is shown in FIG. 3b. The sender, i.e. originating party 130 may respond by sending a special message 302 or email to the DCFB either cancelling the sending of the message, redefining the message type, or confirming the original message to be sent.

If such a restriction rule does not apply for any of the recipients of the message, the DCFB 134 may send the message further in any appropriate manner, such as indicated in FIG. 3b by 304. As illustrated in FIG. 3b, after successful checking by the DCFB 134 the message is forwarded to a sender-SMTP 135 for transmission. FIG. 3b shows that, functionally, the DCFB 134 may be considered part of the email server 132 for transmitting messages. Sending of the message may be based on the simple mail transfer protocol (SMTP) or some other appropriate protocol.

After transmission the message is received by a receiver-SMTP 137, associated with the terminating party 138, and then forwarded to the terminating party 138 itself. The receiver-SMTP 137 and the terminating party 138 both form part of the email client of the receiver 136 as shown in FIG. 3a.

In an alternative embodiment, the checking of outgoing messages may be done in the email client program 130 using restriction rules. The email client program 130 checks the type of the message and the terminating parties before sending the message to the email server 132.

The rules for restricting the sending of information to be used in the checking of messages may be based on the message type and/or the recipient type or recipient location and/or receiver address types. The rules may be defined by determining restriction levels regarding how the message shall be handled and what type of message content is allowed. The rules may contain further subdivisions, e.g. such that the DCFB or the email client program shall take different actions depending on the restriction level and e.g. estimated number of receivers and type of content.

Table 1 shows an example of a set of restriction rules. The restriction level sets out the recipient type which the sending of the message is restricted to.

TABLE 1
Examples of restriction rules based on the type of the recipient.

| | | | Exemplifying |
|---|---|---|---|
| | | Allowed | message |
| Domain | Definition | communication | restriction level |
| @nokia.com | Employee's | Internal company | No restrictions |
| | own company | communication | |
| | domain | | |
| @dna.fi | Employee's | External company | Only “Company |
| | mobile operator | communication | confidential” and |
| | domain | | “Public” data |
| @vodafone.co.uk | Employee's | Customer | Only “Customer |
| | customer | confidential | confidential” |
| | domain | communication | And “Public” |
| | | | data |
| Void | Anybody | No restriction to | Only “Public” |
| | | public | data |
| | | communication | |

In addition, or alternatively, the restriction rules may be based on the type of the message. The message may be classified using restriction levels, such as “private”, “confidential” and “public”. Table 2 shows an example of a set of rules in accordance with this embodiment.

TABLE 2
Examples of restriction rules based on the type of the message.

| Message | | Originating | Terminating |
|---|---|---|---|
| class | Definition | party | Party |
| Private | Internal company | Company A | Company A internal |
| | communication | | |
| Company | Internal and external | Company A | Company A internal, |
| confidential | company | | External trusted |
| | communication | | service of Company A |
| Customer | Customer | Company A | Company A internal, |
| confidential | confidential | | External trusted |
| | communication | | service of Company A, |
| | | | External trusted |
| | | | service of Customer |
| Public | Information with no | Company A | Any terminating party |
| | restriction of | | |
| | distribution | | |

Preferably, the information of the type of the message is jointly used with the information of the type of the recipient, as shown in the example of Table 2. A message may be classified, for example, in accordance with the restriction rules of Table 2. Terminating parties, to which the sender is likely to send any messages, are defined in accordance with the restriction rules of Table 1 using the same classification of data as in Table 2.

As shown in Table 1 the restriction rules may be defined based on the type of receiver address. The receiver address types may be defined based e.g. on the estimated number of receivers behind a receiver group address, such as a mailing list address. Furthermore, content restrictions of messages sent to a mailing list may be defined, especially if the mailing list, or group address, can contain receivers outside the home domain of the sender.

In an embodiment, it may be defined that a certain number of receivers may receive a selected or determined type of a message simultaneously. When the number of the receivers defined by the originating party exceeds the predefined number, a warning message may be sent to the originating party, sending of the message may be denied or another appropriate action may be taken.

In a further embodiment, it may be determined that a message is to be modified before sending. The modification may be removing an attachment file, such as any attachment or a selected type of attachment. The modification of the message may be carried out automatically or consent of the originating party may be asked.

Some examples of different types of receiver addresses and the corresponding restriction rules and restriction actions are listed in Table 3. It is noted that a message can be addressed both to groups and individuals in the same time and therefore has to be checked correspondingly.

It shall be appreciated that the examples given in Tables 1 to 3 are given only for illustrating some embodiments of the invention. The invention is not limited to these exemplifying embodiments. For example, defining restriction rules and/or restriction actions may comprise numerous combinations and variations of different kinds of parameters.

TABLE 3
Examples of receiver address types and restriction rules and actions

| | | Content | |
|---|---|---|---|
| | Estimated | restriction | Exemplifying |
| | amount of | rules, content | message restriction |
| | receivers | type | rule and action |
| Type of receiver | | | |
| address, Individual | | | |
| receivers | | | |
| Single individual | Not | Applicable, | Message to be sent |
| receiver in | applicable | May be defined | |
| company's domain | | | |
| Several listed | Applicable | Applicable, | Message to be sent |
| individual receivers | May be | May be defined | |
| in company's | defined | | |
| domain | | | |
| Single receiver or | Applicable | Applicable, | Return warning |
| list of individual | May be | May be defined | message to sender, |
| receivers outside | defined | | send message if |
| company's domain | | | sender agrees |
| Type of receiver | | | |
| address, | | | |
| Group addresses | | | |
| Employee's own | 50 or | ‘Confidential’ | Return warning |
| company domain | more | attachment not | message to sender, |
| | | allowed | send message if |
| | | | sender agrees |
| Employee's own | 10 or | ‘active content’ | Message to be sent, |
| company domain | more | e.g. .exe-files | inform sender that |
| | | attachment not | attachment was |
| | | allowed | removed |
| | | (removed) | |
| Employee's own | Less | No restrictions | Message to be sent |
| company domain | than 10 | | |
| Contains or may | Not | Only “Public” | Return warning |
| contain receivers | applicable | data, Document | message to sender, |
| outside own | | attachments | send message if |
| company's domain | | allowed | sender agrees |
| Contains or may | Applicable | No attachment | Return warning |
| contain receivers | Can be | allowed | message to sender, |
| outside own | defined | | send message if |
| company's domain | | | sender agrees |
| Group address of | Applicable | Only “Customer | Return warning |
| specific customer | Can be | confidential” | message to sender, |
| domain | defined | and “Public” data | send message if |
| | | | sender agrees |
| Group address of | Applicable | Only “Public” | Return warning |
| non-company | Can be | data | message to sender, |
| domain | defined | | send message if |
| | | | sender agrees |

An embodiment is described below referring to the exemplifying restriction rules of above tables. The user may send an email with company confidential content to matti.salmi@nokia.com. In such a case, the DCFB or email client program does not issue any warning since the domain @nokia.com has no restrictions.

In an embodiment, the user may further try to send an email with private content to matti.salmi@yahoo.com. The user has classified the email as “private”. The DCFB or the email client program may issue a warning that the domain @yahoo.com is not on the restriction list. The warning may inform the sender that the email being classified as “private” will not be sent. In certain embodiments, the user cannot agree for this class of message to be sent even after the warning message. In certain embodiments, the user may be able to change the classification if needed.

The embodiments may also be implemented in the IMS service environment. For example, two or more IMS users may have a voice call employing an unrestricted voice connection. However, sharing files could be restricted and thereby there may be a need to warn the sender against sharing files. The warning may be implemented based on information defining a restriction level for certain types of files or information of certain recipients.

In the IMS, a serving controller, such as a serving call state control function (S-CSCF), an application server (AS), another network entity or the terminal of the originating party can check whether the originating party should be warned against establishing a session with the requested terminating party. In an embodiment, the subscriber data stored in a subscriber information register, such as the home subscriber server (HSS), may contain information relating to the restriction rules for sending messages. In another embodiment, a dedicated IMS application server or another network element can be used for providing the restriction rules. The restriction rules can also be stored in the originating terminal. The restriction rules in the terminal and in the network normally need to be synchronized so that the user can be sure that all messages that are sent are treated with the same (or similar) rules, irrespective whether the rule handling is in the terminal or in the network.

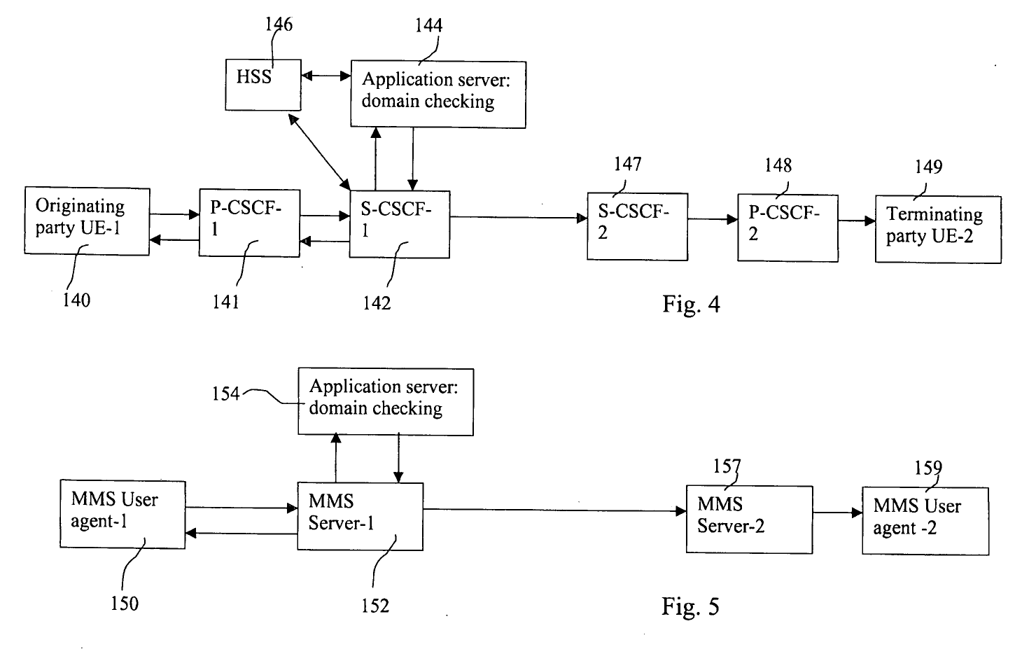

FIG. 4 illustrates an embodiment implemented in the IMS. The originating party 140, such as a user equipment (UE-1), sends a message via a proxy call state control function (P-CSCF-1) 141 to an S-CSCF-1 142 providing the control entity the user equipment 140 needs to be registered with to communicate with the system. In the FIG. 4 embodiment, the S-CSCF-1 142 then queries the application server 144 configured for domain checking to check whether a restricting rule for sending messages has been set for the originating party 140. The restricting rule may be set by the originating party 140, or on the originating party's behalf, by the subscriber (the one who pays the bill), by the network operator, or by anyone having access to restricting rules database. If there is at least one restriction rule set for the originating party 140, the application server 144 then checks if the restriction rule(s) apply to the message type and/or the addressed terminating party or type of receiver address in question. If the checking shows that sending of the message is to be restricted the application server 144 advises the S-CSCF-1 142 accordingly. The S-CSCF-1 142 may send an inquiry to the originating party 140. The originating party 140 may respond by sending a response to the S-CSCF-1 142 either cancelling the sending of the message, redefining the message type, or confirming the original message to be sent.

In the FIG. 4 embodiment, the function of the application server 144 can be carried out also by the HSS 146. The checking whether a restriction rule applies or not may also be carried out by the HSS 146 or the S-CSCF-1 142

If no restriction rule applies for any of the recipients of the message, the IMS message may be sent further in any appropriate manner. In the FIG. 4 embodiment, the message is sent from the S-CSCF-1 142 to another S-CSCF-2 147. The S-CSCF-2 147 routes the message via another P-CSCF-2 148 to the terminating party 149, such as a receiving user equipment (UE-2).

In the IMS, also the type of the session or the requested quality of service (QoS) level may be taken into account. The checking may only be needed for certain types of sessions, e.g. data transfers, whilst voice services may be fully allowed.

In an embodiment, rules may be defined in the similar manner as described above for the purposes of checking by the network or by the terminal if it is allowed for the originating party, e.g. of an IMS session, to receive a message or data from the terminating party during or after the session.

In an embodiment, users may have the following session initiation protocol uniform resource locators (SIP URL): user A sip:a@Nokia.com, user B sip:b@sonera.fi and user C sip:c@nokia.com. The user A starts an IMS voice session with the user B and the user C. During the voice session the user A starts a messaging session with the user B and the user C. The user A presses the function “Send” to send a first message to the user B and the user C. The S-CSCF may warn the user A that the domain @sonera.fi is not on the restriction list and/or that the IMS message is not classified. The warning preferably continues, if the user A tries again to send the message to both the user B and the user C. In an embodiment, the user A may then cancel the sending and send the message only to the user C. In another embodiment, the S-CSCF or the application server may automatically send the message only to the allowed terminating party, in this case to the user C. The user A may be informed that the message was not sent to the user B.

The embodiments may also be implemented in a multimedia message service (MMS) transmission as illustrated in FIG. 5. The originating party, such as a MMS user agent-1 150 sends a message to the MMS server-1 152 managing the MMS sending. In the FIG. 5 embodiment, the MMS server-1 152 may then query the application server 154 configured for domain checking to check whether a restricting rule for sending messages has been set for the originating party 150.

If there is at least one restriction rule set for the originating party 150, the application server 154 or the MMS server-1 152 then checks if the restriction rule(s) apply to the message type and/or the terminating party in question. If the checking shows that sending of the message is to be restricted, the MMS server-1 152 may send an inquiry to the originating party 150. The originating party 150 may respond by sending a response to the MMS server-1 152 either cancelling the sending of the message, redefining the message type, or confirming the original message to be sent.

If such a restriction rule does not apply for any of the recipients of the message, the MMS message may be sent further in any appropriate manner. In the FIG. 5 embodiment, the message is sent from the MMS server-1 152 to another MMS server-2 157. The MMS server-2 157 routes the message to the terminating party 159, such as a receiving MMS user agent-2.

In an embodiment, the user may have defined a recipient number, e.g. 04077558888, to be related to the restriction levels “public” and “private”. The user may send an MMS with private content and classified as “private” to the recipient number 04077558888. In this embodiment, the MMS server does not warn him as 04077558888 is defined to relate to the restriction level “private” in addition to “public”.

In an embodiment, the user sends an MMS with company confidential content to matti.salmi@dna.fi. In this embodiment, the MMS server then warns the user that the domain @dna.fi is defined to be in the public domain. The MMS server may ask what action the user wants to take. The user may have alternative actions to select: the sending of this message may be cancelled, the user may reclassify the message or the user may select to send the message despite of the warning. In certain embodiments, only one or two of these alternatives may be possible. In certain embodiments, some other alternatives may be provided.

The embodiments may also be applicable to circuit switched telephone calls. For example, it is possible to define series of numbers to be checked on behalf of the user and warned against before the call is established. This type of value added service may provide advantages in particular in the intelligent networks (IN).

Alternatively, the restriction information may be stored in the terminal used by the originating party. In such a case, the terminal checks the type of the message, the terminating parties and type of receiver address and decides whether the message may be sent further.

In an embodiment, rules may be defined for a Push-to-Talk over cellular (PoC) service which may be based on an always-on connection allowing a subscriber a direct access to a service without a need of dialing or other such additional measures. In the embodiment applied for the PoC service, the user may be warned e.g. by an initial warning tone, message or indicator in the display of the mobile terminal that certain types of receivers are receiving the voice or multimedia message. This check and indication can originate from the network. In an alternative, the user of the terminal can define and set this indication/warning message in the terminal for certain PoC groups.

Although the invention has been described in the context of particular embodiments, there are several variations and modifications, which may be made to the disclosed solution without departing from the scope of the present invention as defined in the appended claims. For example, the communication system used in the various embodiments may be another communication system and the network entities referred to may be called with different names in various communication systems. These entities may also carry out various additional tasks.

1. A method for controlling sending of messages in a communication system, the method comprising:
providing a network entity with restriction information associated with terminating parties in the communication system;
determining at least one terminating party for a message to be sent; and
controlling sending of the message based on the restriction information.

2. The method according to claim 1, wherein the controlling step comprises deciding if the sending of the message is allowed or denied.

3. The method according to claim 2, further comprising, when the sending of the message is denied, providing a warning message in response to a sending command.

4. The method according to claim 1, further comprising defining the restriction information associated with the terminating parties to comprise a restriction level for sending the message to the at least one terminating party.

5. The method according to claim 4, further comprising defining the restriction level in function of a type of the message.

6. The method according to claim 5, wherein defining the restriction level comprises classifying the message as private, confidential or public.

7. The method according to claim 4, further comprising defining the restriction level in function of a type of the at least one terminating party.

8. The method according to claim 7, wherein defining the restriction level comprises classifying the terminating party as private, confidential or public.

9. The method according to claim 4, further comprising defining the restriction level for a receiver group address in function of an estimated amount of terminating parties.

10. The method according to claim 2, further comprising, when the sending of the message is denied, determining an action to be taken in relation to the message to modify the message into a form in which the sending is allowed.

11. The method according to claim 10, further comprising modifying the message by removing a selected type of attachment file before allowing the sending of the message.

12. A computer program, comprising program code means embodied on a computer readable medium, said computer program controlling a computer to perform the steps of:
providing a network entity with restriction information associated with terminating parties in a communication system;
determining at least one terminating party for a message to be sent; and
controlling sending of the message based on the restriction information.

13. A communication system, comprising:
a network entity configured to receive and manage restriction information associated with terminating parties in the communication system;
determining means configured to determine at least one terminating party for a message to be sent; and
controlling means configured to control sending of the message based on the restriction information.

14. The communication system according to claim 13, further comprising decision means configured to decide if the sending of the message is allowed or denied.

15. The communication system according to claim 14, further comprising response means configured to provide a warning message in response to a sending command when the sending of the message is to be denied.

16. The communication system according to claim 13, wherein the restriction information comprises a restriction level for sending the message to the at least one terminating party.

17. The communication system according to claim 16, wherein the restriction level is defined in function of a type of the message.

18. The communication system according to claim 17, wherein the message is classified as private, confidential or public.

19. The communication system according to claim 16, wherein the restriction level is defined in function of a type of the at least one terminating party.

20. The communication system according to claim 19, wherein the terminating party is classified as private, confidential or public.

21. The communication system according to claim 16, wherein the restriction level is defined for a receiver group address in function of an estimated amount of terminating parties.

22. The communication system according to claim 14, further comprising determining means configured to determine an action to be taken in relation to the message to modify the message into a form in which the sending is allowed.

23. The communication system according to claim 22, further comprising modifying means configured to modify the message in accordance with the determined action.

24. The communication system according to claim 23, wherein the modifying means are configured to select and remove attachment files in accordance with the determined action.

25. The communication system according to claim 13, wherein the network entity is selected from a group comprising at least one of a user equipment, a serving controller, an application server and a subscriber information register.

26. The communication system according to claim 13, wherein the network entity comprises an email server, the controlling means comprises a domain checking function block connected or included in the email server, and the terminating party comprises an email client of a receiver.

27. The communication system according to claim 13, wherein the network entity comprises a serving controller in an Internet Protocol Multimedia subsystem, the controlling means is included in an application server communicating with the serving controller, and the terminating party comprises a user equipment connected to the Internet Protocol Multimedia subsystem.

28. The communication system according to claim 13, wherein the network entity comprises a multimedia message service server, the controlling means is included in an application server communicating with the multimedia message service server and the terminating party comprises a multimedia message service user agent of a receiver.
